(19) United States
(12) Patent Application Publication
(10) Pub. No.: US 2026/0286087 A1
(43) Pub. Date: Sep. 24, 2026

(54) CONTINUOUS SIZE-EXCLUSION MEMBRANE SEPARATION OF POLYURETHANE DECONSTRUCTION PRODUCTS FOR THE RECOVERY OF PRISTINE POLYOLS

(71) Applicant: Alliance for Energy Innovation, LLC, Golden, CO (US)

(72) Inventors: Seung Eun LEE, Avada, CO (US); Henry Louis CATER, Lakewood, CO (US); Stephen Hughes DEMPSEY, Denver, CO (US); Katrina Marie KNAUER, Denver, CO (US); Gregg Tyler BECKHAM, Golden, CO (US); Patrick Owen SABOE, Golden, CO (US)

(21) Appl. No.: 19/573,401

(22) Filed: Mar. 20, 2026

Related U.S. Application Data
(60) Provisional application No. 63/775,531, filed on Mar. 21, 2025.
(60) Provisional application No. 63/775,587, filed on Mar. 21, 2025.

(51) Int. Cl. C08J 11/24; B01D 61/02

(52) U.S. Cl. CPC C08J 11/24; B01D 61/027; C08J 2375/08

(57) ABSTRACT

Described herein are systems and methods for the conversion of polymers into monomer and polymer components utilizing deconstruction (for example, acetic acid solvolysis) and filtration of both insoluble and soluble reaction products.

### CROSS-REFERENCE TO RELATED APPLICATIONS

This application claims priority from U.S. Provisional Patent Application Nos. 63/775,531 and 63/775,587, both filed on Mar. 21, 2026, the contents of which are incorporated herein by reference in their entirety.

### CONTRACTUAL ORIGIN

This invention was made with government support under Contract No. DE-AC36-08GO28308 awarded by the Department of Energy. The government has certain rights in the invention.

### BACKGROUND

As the global market of polyurethanes (PU) is projected to hit $73 billion by 2028, interest in novel recycling methods that preclude the current build-up of these materials in landfills and the environment is set to grow. Yet, in 2016, of the 2900 kt of polyurethanes produced, only 390 kt were recycled and returned to market. In can be seen from the foregoing that there remains a need in the art for new, efficient methods for recycling polyurethane-based polymers into useful products, including polyols and acetylated monomers.

### SUMMARY

Described herein are systems and methods for the conversion of polymers into monomer and polymer components utilizing deconstruction (for example, acetic acid solvolysis) and filtration of both insoluble and soluble reaction products.

This method can work on any polymer containing some high-molecular weight component and some low-molecular weight component as long as they can be preferentially deconstructed. The high-MW component is typically a polyether (polyol) for polyurethanes but could also be a polyester, while in other systems (i.e., epoxy amine resins) it's possible to see polyamines or polyamides (and many others).

Other methods of deconstruction may also be used, including for example, acidolysis, alcoholysis, hydrolysis and glycolysis.

The systems and methods described herein are significant in two ways. Firstly, the discovery that acetic acid solvolysis (“acetolysis”) chemical recycling/deconstruction on PUs without destruction of valuable subunits (i.e. polyol prepolymer segments) means that our approach is competitive with other chemical recycling methods. Secondly, a separation set-up is described which demonstrates preliminary success in the purification of acetylated PU deconstruction products, notably the enrichment of polyols. Further, it was shown that the separation set-up could be adapted to concentrate all deconstruction species (solvent permeation), if desired for a chemical process. Moreover, dead-end filtration separation was shown to occur in acetic acid, the original reaction solvent, without dilution or concentration. In the interest of closed-loop recycling, it is envisioned that pristine acetylated polyol can be isolated and fed into new PU syntheses, following deacetylation and a return to the polymer diol. A solvolysis procedure to remove acetate end groups from polyols (e.g., poly(propylene glycol)) using ethanol and catalytic acid is also described herein. Similarly, deacetylation of butane-diol diacetate (BDODA) and acetamide small molecules will yield the butane-diol building block, and diamines, the latter of which can be upcycled for reaction with carbonates to produce isocyanate-free polyurethanes, or novel polymer resins/coatings via reaction with epoxy groups. Diamines are also industrially reacted with phosgene to produce diisocyanates which are universal substrates for polyurethane formation. The deacetylation of acetamides to their corresponding amines was also performed successfully.

The present methods can also be broadly applied to other PUS, e.g., those composed of polyether, polyester, or block copolymer polyol segments, or other “hard” block segments (toluene- or hexamethylene-based) or any other macromolecules possessing recalcitrant polymer segments.

Lastly, it is reasonable to imagine the application of a similar approach to deconstruction products from commercial epoxy-amine resins, which often contain polyamines (and other oligomeric species) of significantly higher MW than the other components, or in any other polymer system that meets the following requirements: 1) multiple chemical linkages are present (i.e. urethanes and ethers, for PUs) and 2) acetolysis has different rates for said linkages.

In an aspect, provided is a method comprising: a) providing a polymer containing polyols; b) reacting the polymer with acetic acid, thereby generating a plurality of products; and c) separating the plurality of products via filtration. An example polymer is polyurethane. The products may be acetylated products.

The separation step may comprise: removing insoluble acetylated products via membrane vacuum filtration; and removing soluble acetylated products via nanofiltration membrane separation, for example, dead-end nanofiltration membrane separation, continuous cross flow nanofiltration membrane separation, multi-stage cascading continuous cross flow nanofiltration membrane separation, or a combination thereof. Acetone may be added to the solution prior to the removal of soluble products.

The acetylated products may comprise diacetylated diamino diphenylmethane (DADDM), toluene diacetamide (TDA), diacetylated hexamethylene diamine (DAHMDA), diacetylated polyols, butane-diol diacetate (BDODA), or a combination thereof.

The method may further comprise crystalizing the plurality of acetylated products after the reacting step, thereby generating insoluble acetylated products, for example, at a temperature less than or equal to 50° C., 25° C., or 0° C. The step of reacting the polymer with acetic acid may be performed at a temperature greater than or equal to 100° C., 200° C., 220° C., or optionally, 250° C. In an aspect, provided is a system for performing the methods described herein.

### BRIEF DESCRIPTION OF DRAWINGS

Some embodiments are illustrated in referenced figures of the drawings. It is intended that the embodiments and figures disclosed herein are to be considered illustrative rather than limiting.

FIGS. 1A-1F provide size-exclusion chromatograms for 6 model polyurethanes illustrating original PU prior to acetolysis, pristine commercially purchased polyTHF or poly(propylene glycol) used to construct the original PU, and aliquots from PU acetolysis reaction (20 wt %, 220° C.) at 0.5, 1, 1.5, 2, 2.5, 3, 4, 5 and 6 h timepoints (grey to black), showing appearance of polyol resulting from acetolysis. Preservation of narrow molecular weight distributions indicates that any minor loss in molar mass occurs at the chain-end only.

FIG. 2 provides time-coursed size-exclusion chromatograms from post-consumer thermoset polyurethane foam acetolysis (10 wt %, 220° C.) aliquots at 20, 30, 60, 90, and 120 min timepoints (grey to black), showing appearance of polyol resulting from acetolysis.

FIG. 3 shows first-step removal and isolation of DADDM via vacuum filtration with a 0.2 μm polyethylene filter, and subsequent membrane nanofiltration to separate solubilized DADDM in acetic acid from polyol. Also shown is 1H nuclear magnetic resonance spectrum of isolated DADDM crystals after filtration and vacuum drying.

FIG. 4 illustrates chemical structures of diacetylated diamino diphenylmethane (DADDM) and toluene diacetamide (TDA).

FIG. 5 shows the rejection rates of polyols vs. BDODA across 3 different nanofiltration membranes.

FIG. 6 provides flux data for different solvents, revealing improved permeance when diluting with acetone.

FIG. 7 illustrates the investigation of flux with oNF2 showing improved flux with dilution with acetone.

FIG. 8 shows a continuous cross-flow membrane separation apparatus that may be utilized to separate PU acetolysis deconstruction products via size-exclusion under high pressure.

FIG. 9 shows dead-end filtration results showing retention rates with significant initial separation of small molecules (DADDM, BDODA) from polyols via two-step vacuum filtration and nanofiltration, and a second separate nanofiltration membrane showing rejection of DADDM in preference of allowing BDODA to largely permeate.

FIG. 10 shows extensive dead-end filtration studies, looking at the respective rejection rates of 6 mock model PU deconstruction mixtures (comprising approximately 70 wt % polyol, 5 wt % acetamide, and 5 wt % BDODA) across 3 different organosolvent nanofiltration membranes.

FIGS. 11A-11B show an image (FIG. 11A) and schematic (FIG. 11B) of an exemplary in-house custom-built multi-stage cascading cross-flow membrane nanofiltration separation system, developed for the separations of PU deconstruction components.

### DETAILED DESCRIPTION

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

The provided discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations, may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

Example 1-Continuous Size-Exclusion Membrane Separation of Polyurethane Deconstruction Products for the Recovery of Pristine Polyols

Polyurethanes (PUs) consist of glassy, typically aromatic (>90%), subunits tethered by soft polymer (polyol) segments and butane-diol linkages (or other chain extenders). In the interest of PU waste recycling, heating in acetic acid (“acetolysis”) has been shown to deconstruct PUs into their acetylated constituent parts, namely aromatic/glassy acetamides, bis-acetate terminated polyols (e.g., of polypropylene glycol, polytetrahydrofuran (polyTHF)), and butane-diol diacetate (BDODA), with loss of CO₂ (Scheme 1).

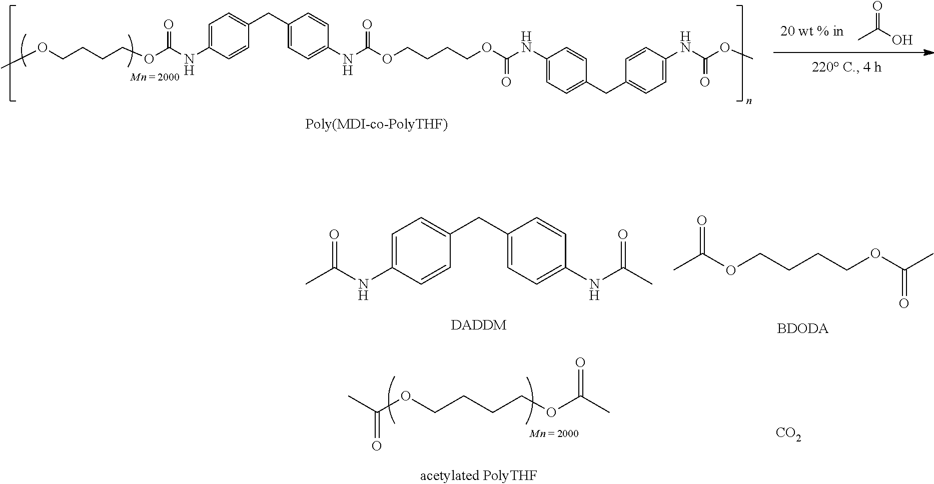

Scheme 1—Acetolysis of a representative model PU into respective acetylated deconstruction products and carbon dioxide.

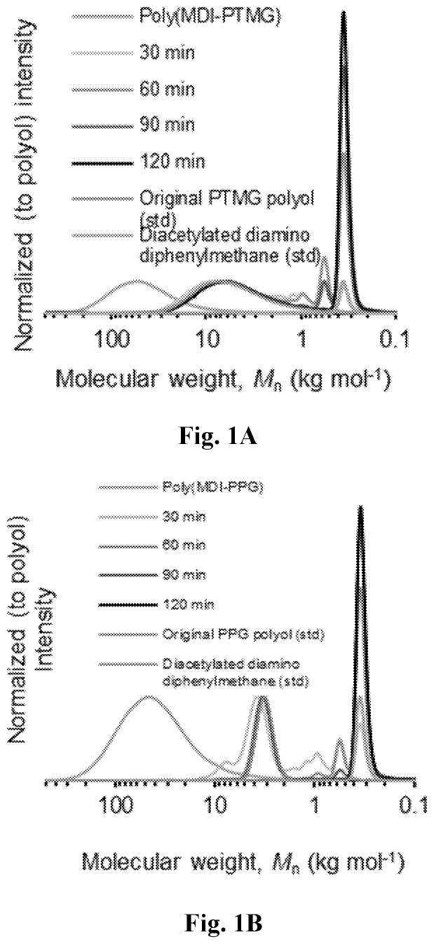

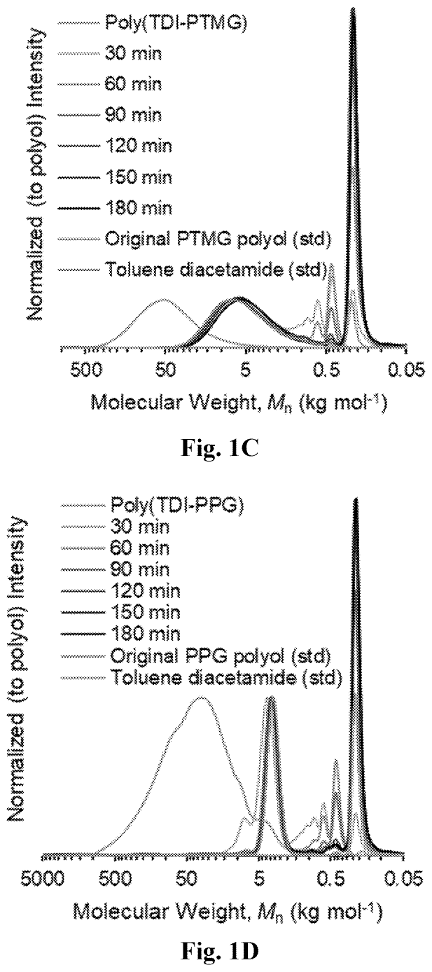

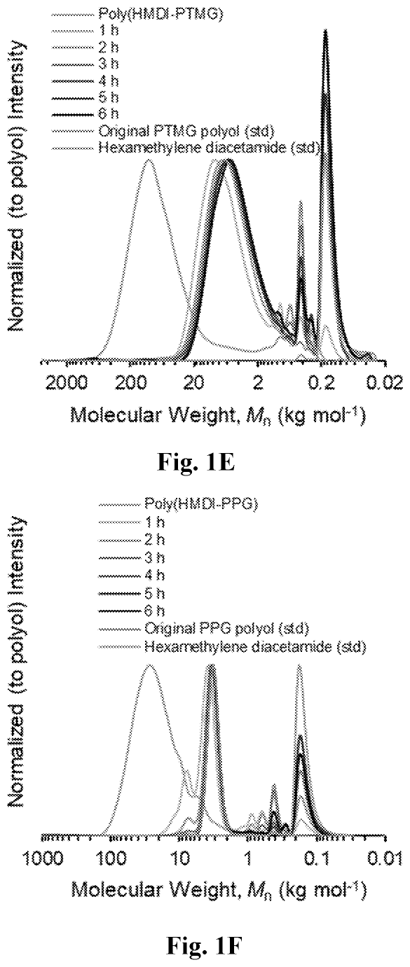

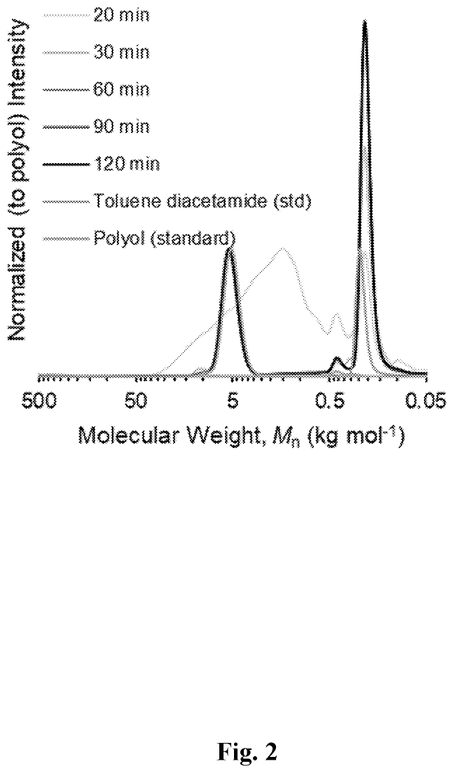

Acetic acid solvolysis at elevated temperature is highly selective for cleavage of urethane linkages only, whilst polyol repeat units remain unaffected or exhibit only minor chain-end cleavage over relevant timescales. This was elucidated from size-exclusion chromatography data obtained from the acetolysis of 6 model PUs formed from one of methylene diisocyanate, toluene diisocyanate, or hexamethylene diisocyanate, with one of either polyTHF or poly(propylene glycol), and with butane-diol (FIG. 1).

Building on this discovery, it followed that acetic acid solvolysis at elevated temperature is highly selective for cleavage of urethane linkages only with a post-consumer thermoset PU foam, whilst polyol repeat unit remain recalcitrant.

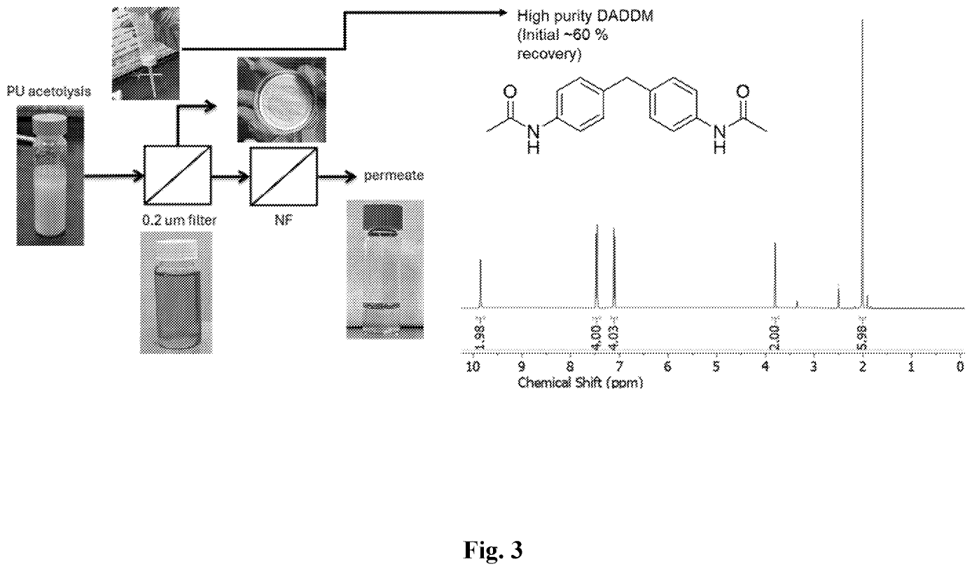

Further, following acetolysis and subsequent cooling to room temperature, the acetylated deconstruction products could be separated, isolated, and recovered via the following protocol: insolubles suspended in acetic acid were removed via simple membrane vacuum filtration using a 0.2 μm polyethylene filter. For example, 1H NMR spectroscopy revealed high purity diacetylated diamino diphenylmethane (DADDM) was isolable in this fashion in 60% yield (FIG. 3).

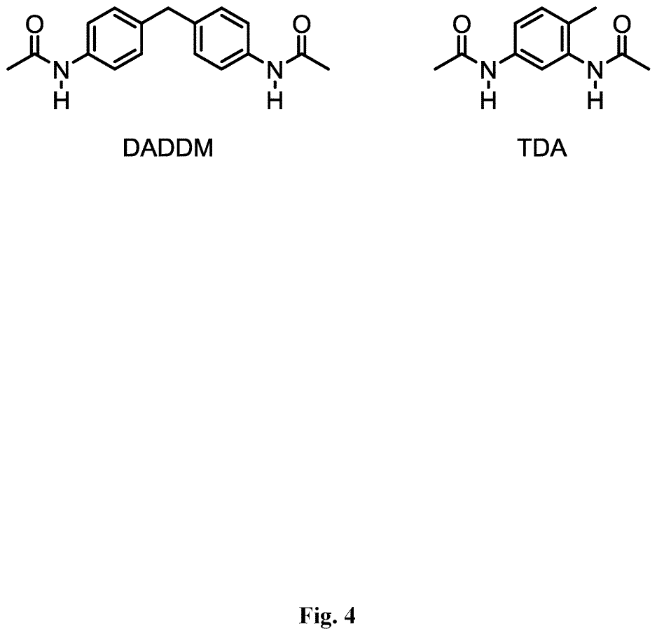

Building on this discovery, optimized crystallization of acetamide components were investigated for diacetylated diamino diphenylmethane (DADDM) and toluene diacetamide (TDA) (FIG. 4).

In a crystallization experiment, mock solutions were generated corresponding to approximate polyurethane deconstruction products, specifically 25% acetamide, 5% butane-diol diacetate (BDODA), and 70% diacetylated polyol, by mass.

Acetamide crystals were isolated from the following compositions which were investigated: DADDM/PTMG/BDODA, DADDM/PPG/BDODA, TDA/PTMG/BDODA, TDA/PPG/BDODA at temperatures ranging from −10 to 22° C. Solutions were allowed to equilibrate for 2 h. Aliquots were removed from the solution phase and the ratio of acetamide to polyol was compared with the initial ratio at t=0 to deduce the extent of crystallization. The results which yielded isolable crystals are presented in Tables 1~4 below.

TABLE 1
DADDM/PTMG/BDODA crystallization results.

| Temperature (° C.) | Wt % | % crystallized |
|---|---|---|
| 10 | 20 | 67 |
| | 40 | 87 |
| 21 | 20 | 62 |
| | 40 | 80 |

TABLE 2
DADDM/PPG/BDODA crystallization results.

| Temperature (° C.) | Wt % | % crystallized |
|---|---|---|
| 10 | 20 | 67 |
| | 40 | 90 |
| 21 | 20 | 69 |
| | 40 | 81 |

TABLE 3
TDA/PTMG/BDODA crystallization results.

| Temperature (° C.) | Wt % | % crystallized |
|---|---|---|
| 0 | 20 | 47 |
| | 40 | 88 |
| 21 | 20 | — |
| | 40 | 58 |

TDA/PPG/BDODA crystallization results.

| Temperature (° C.) | Wt % | % crystallized |
|---|---|---|
| 0 | 20 | 22 |
| | 40 | 88 |
| 21 | 20 | — |
| | 40 | 76 |

Isolated crystals were washed once with acetic acid via vacuum filtration and characterized by ¹H NMR, revealing highly pure acetamides. Hence, we have demonstrated the ability to selectively remove up to 90% of aromatic acetamides from the polyurethane acetolysis product mixture. Therefore, a product mixture of polyol and butane-diol diacetate contaminated with 25 wt % aromatic acetamide, can be reduced down to 2.5 wt % aromatic acetamide, prior to membrane filtration.

A separation method may comprise post-acetolysis concentration of the crude reaction mixture to remove some amount of acetic acid, and aid crystallization from solution (i.e. increasing saturation of solution.

In the next step, dead-end nanofiltration was used to investigate the separation of polyols and BDODA (two-component system, assuming quantitative acetamide crystal removal at this stage). Borsig oNF2 (Molecular-weight cut-off 350 Da), oNF1 (molecular-weight cut-off 600 Da), and oNF3 (molecular-weight cut-off 900 Da) membranes are described herein.

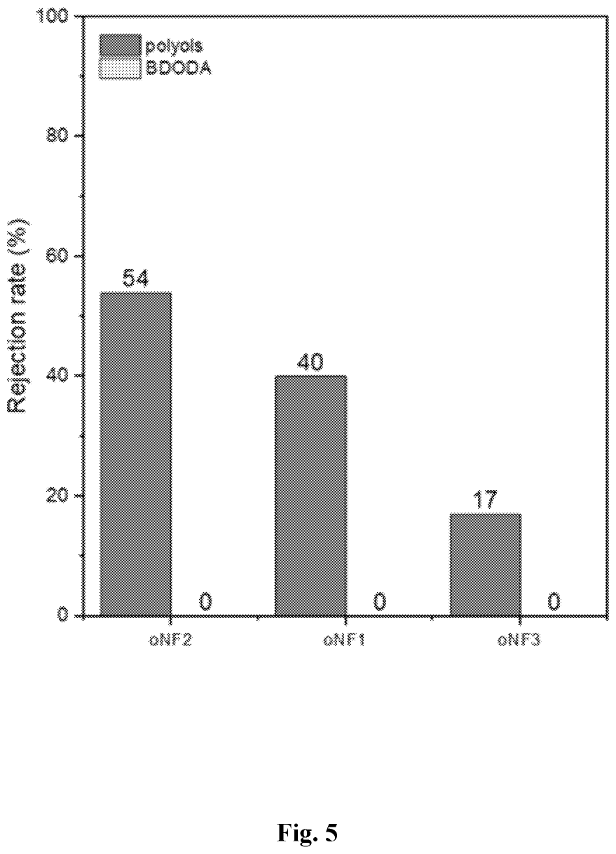

After the separation process, all membranes exhibited 100% BDODA permeance. Among them, the oNF2 membrane, which has the smallest pore size, demonstrated the highest rejection of polyols, with a rejection rate of approximately 54% in pure acetic acid solvent (FIG. 5).

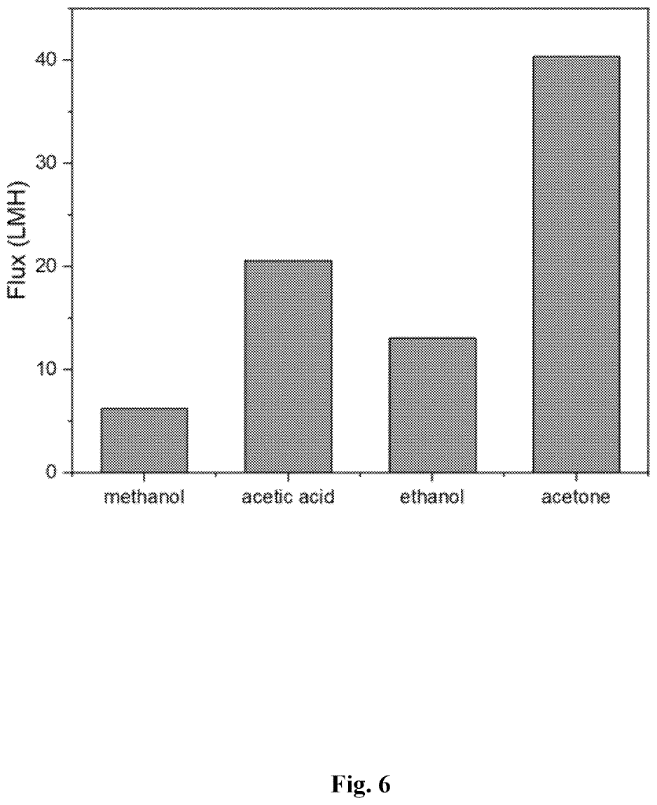

The permeability of various solvents was also studied to explore the potential for improving permeance flux by considering sample dilution. Acetic acid exhibited a higher flux compared to methanol and ethanol, while acetone showed the highest flux, approximately twice that of acetic acid (FIG. 6).

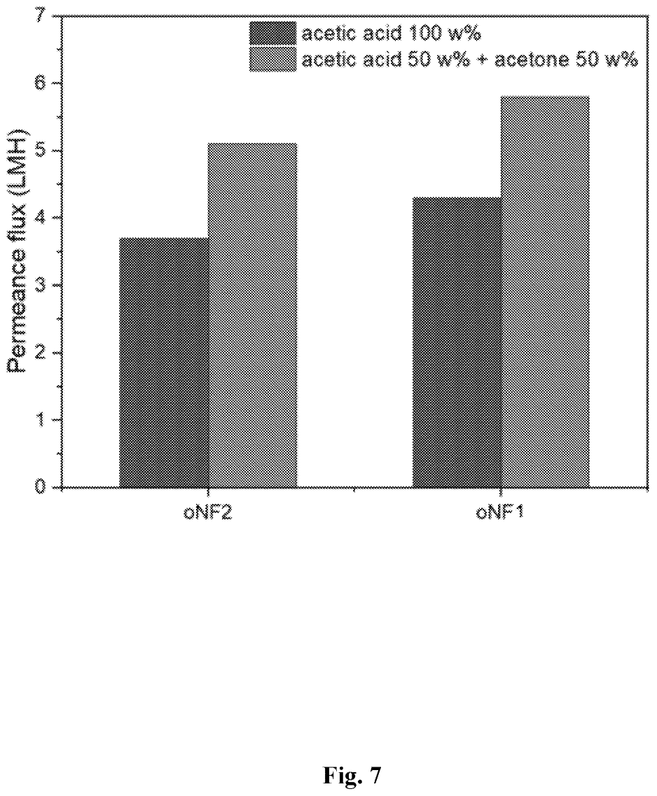

A comparison of permeance flux between pure acetic acid (100 wt %) and a 50:50 mixture of acetic acid and acetone showed a flux improvement of approximately 1.4 times (FIG. 7). When the solvent composition was adjusted to 50 wt % acetic acid and 50 wt % acetone, the rejection rates of polyols and BDODA remained comparable or slightly improved.

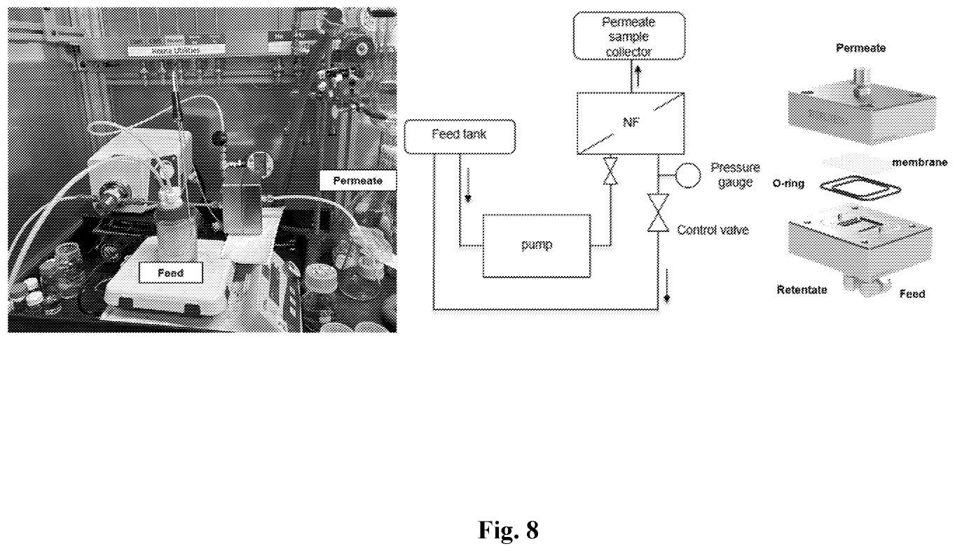

Soluble components in acetic acid (homogeneous fraction) may then be subjected to dead-end nanofiltration (NF) membrane separation (FIG. 3) or continuous cross-flow NF membrane separation (FIG. 8) to discriminate acetylated products based on their molecular weight/size. An added benefit of cross-flow NF its ability to reduce membrane fouling, allowing the system to operate in continuous mode.

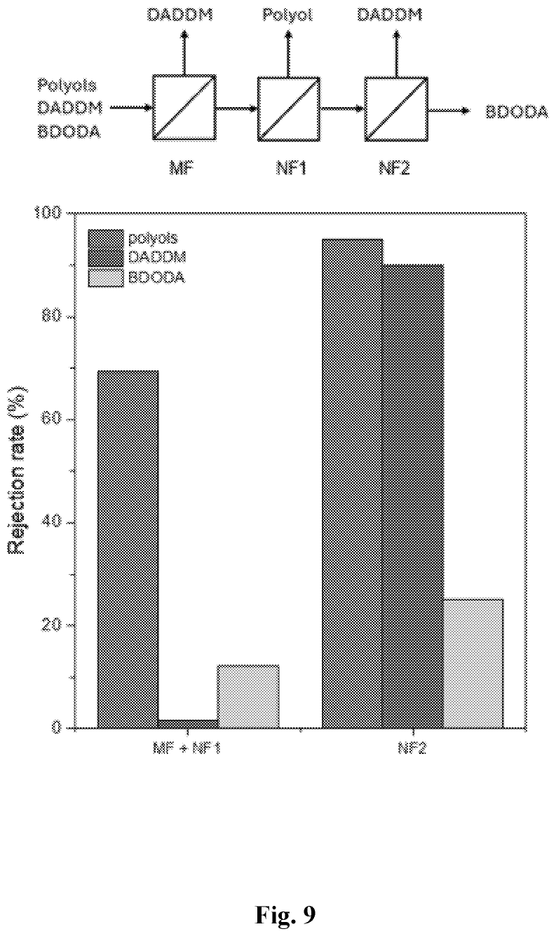

Individual dead-end filtration studies were conducted to screen multiple membranes and determine relative rejection rates of acetylated deconstruction products for the model PU, namely acetylated polyTHF (polyol) from diacetyl diamino diphenylmethane (DADDM) (if residual is present following crystallization), and butane-diol diacetate (BDODA). This was shown to work for macromolecules of low molecular weight (~2 kg mol-1). Additionally, the preliminary data shown in FIG. 9 suggests that a set-up utilizing multiple membranes in series could allow for subsequent separation of DADDM from BDODA following initial polyol separation.

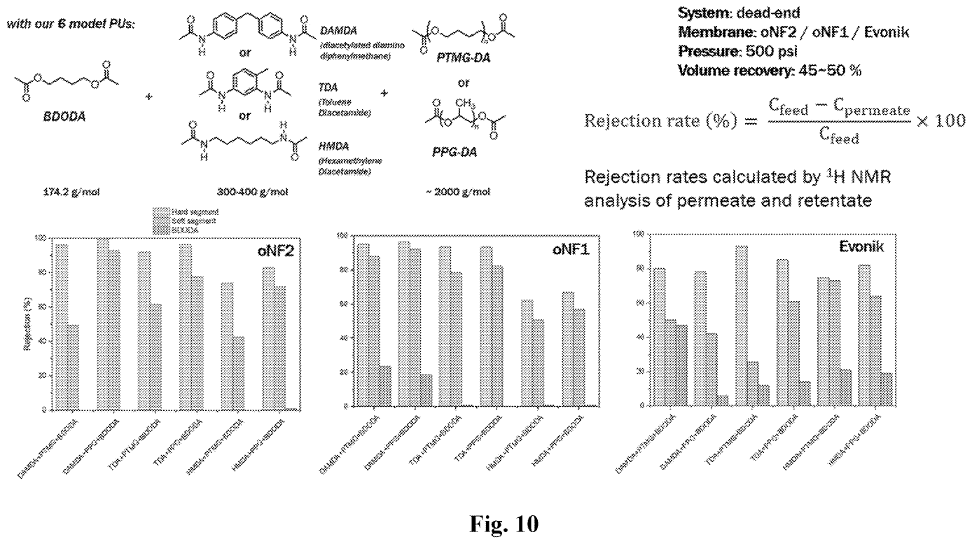

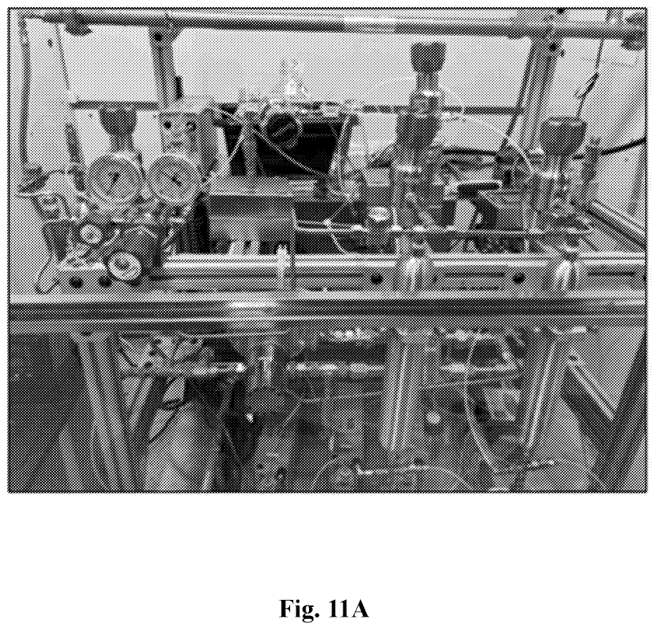

In the case that not all acetamides can be removed, such three-component mixtures may also be subjected to nanofiltration. Data shown in FIG. 10 shows rejection rate results for mock deconstruction mixtures that would result from the described 6 model PUs, across the 3 aforementioned membranes. These results have implications for informing McCabe-Thiele models and multi-stage membrane systems.

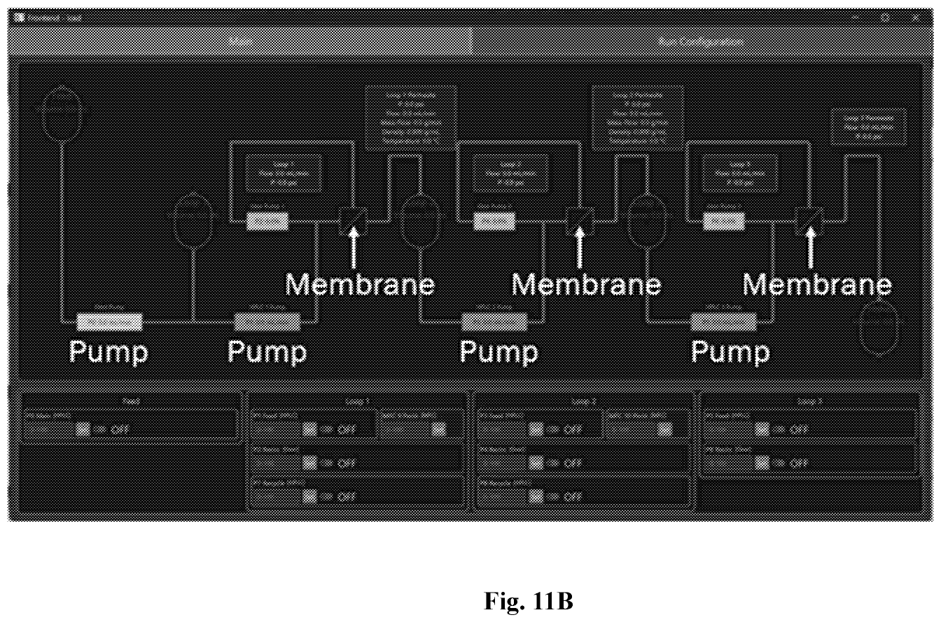

In the case that discrimination between components by membrane filtration is not substantial or to the desired amount, a continuous cross-flow cascading membrane set-up like that shown in FIG. 11 may be employed to iteratively enrich components.

The invention may be further understood by the following non-limiting examples:

Example 1. A method comprising:
providing a polymer containing polyols;
reacting the polymer with acetic acid, thereby generating a plurality of products; and
separating the plurality of products via filtration.

Example 2. The method of example 1, wherein the step of separating comprises:
removing insoluble acetylated products via membrane vacuum filtration; and
removing soluble acetylated products via nanofiltration membrane separation.

Example 3. The method of example 2, wherein the nanofiltration membrane separation comprises dead-end nanofiltration membrane separation or continuous cross flow nanofiltration membrane separation.

Example 4. The method of example 2 or 3, wherein the step of removing soluble acetylated products further comprises adding acetone prior to separation.

Example 5. The method of any of examples 1-4, wherein the acetylated products comprise diacetylated diamino diphenylmethane (DADDM), toluene diacetamide (TDA), hexamethylene diacetamide (HMDA), butane-diol diacetate, or a combination thereof.

Example 6. The method of any of examples 1-5 further comprising: crystalizing the plurality of acetylated products after the reacting step, thereby generating insoluble acetylated products.

Example 7. The method of example 6, wherein the step of crystalizing is performed at a temperature less than or equal to 25° C.

Example 8. The method of any of examples 1-7, wherein the step of reacting the polymer with acetic acid is performed at a temperature greater than or equal to 200° C.

Example 9. The method of any of examples 1-8, wherein the plurality of products are acetylated products.

Example 10. A system for performing any of the methods described in Examples 1-9.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

When a group of substituents is disclosed herein, it is understood that all individual members of that group and all subgroups, are disclosed separately. When a Markush group or other grouping is used herein, all individual members of the group and all combinations and subcombinations possible of the group are intended to be individually included in the disclosure. For example, when a device is set forth disclosing a range of materials, device components, and/or device configurations, the description is intended to include specific reference of each combination and/or variation corresponding to the disclosed range.

Every formulation or combination of components described or exemplified herein can be used to practice the invention, unless otherwise stated.

Whenever a range is given in the specification, for example, a density range, a number range, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter is claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A method comprising:
providing a polymer containing polyols;
reacting the polymer with acetic acid, thereby generating a plurality of products; and
separating the plurality of products via filtration.

2. The method of claim 1, wherein the step of separating comprises:
removing insoluble acetylated products via membrane vacuum filtration; and
removing soluble acetylated products via nanofiltration membrane separation.

3. The method of claim 2, wherein the nanofiltration membrane separation comprises dead-end nanofiltration membrane separation or continuous cross flow nanofiltration membrane separation.

4. The method of claim 2, wherein the step of removing soluble acetylated products further comprises adding acetone prior to separation.

5. The method of claim 1, wherein the acetylated products comprise diacetylated diamino diphenylmethane (DADDM), toluene diacetamide (TDA), hexamethylene diacetamide (HMDA), butane-diol diacetate, or a combination thereof.

6. The method of claim 1 further comprising:
crystalizing the plurality of acetylated products after the reacting step, thereby generating insoluble acetylated products.

7. The method of claim 6, wherein the step of crystalizing is performed at a temperature less than or equal to 25° C.

8. The method of claim 1, wherein the step of reacting the polymer with acetic acid is performed at a temperature greater than or equal to 200° C.

9. The method of claim 1, wherein the plurality of products are acetylated products.
